(19) United States
(12) Patent Application Publication
(10) Pub. No.: US 2017/0083815 A1
(43) Pub. Date: Mar. 23, 2017

(54) CURRENT BEHAVIOR EVALUATION WITH MULTIPLE PROCESS MODELS

(71) Applicant: CA, Inc., New York, NY (US)

(72) Inventors: David Sanchez Charles, Barcelona (ES); Victor Muntés-Mulero, Barcelona (ES); Marc Solé Simó, Barcelona (ES); Li Sun, Cheltenham (AU); Steven Cornelis Versteeg, Ivanhoe (AU)

(21) Appl. No.: 14/859,187

(22) Filed: Sep. 18, 2015

(51) Int. Cl. G06N 5/02

(52) U.S. Cl. CPC G06N 5/022

(57) ABSTRACT

Current behavior can be evaluated to efficiently identify behavioral anomalies with process models of different scopes and/or different degrees of precision. For meaningful behavioral evaluation of an actor (i.e., a user or a device), these multiple process models are constructed with different sets of event logs of a system. A model of a scope of an individual actor and a model of a scope of a group of actors are constructed and used for evaluation. These models of different scope expand “normal” behavior of an actor to include behavior of the group of actors. Although these process models of different scopes likely have different precision, additional models of different precision and/or different scopes can be constructed and used for behavioral evaluation. These different process models allow for behavioral variation within relevant groups of actors.

### BACKGROUND

The disclosure generally relates to the field of data processing, and more particularly to identifying anomalous behaviors of actors in data processing systems.

A system or systems record (or “log”) information about events that occur in a system responsive to interaction between the system and a user/device (“actor”). For instance, a server records read and write events requested by a client, some of which may target a repository accessed through the server. The system(s) records the information to a log or generates a new log depending on the event. This log can be referred to by various names, such as an event log or workflow log. A particular sequence of events can be considered a process instance.

Process mining is applied to previously generated event logs and/or artificial event logs (e.g., event logs created by an administrator/developer based on expected events) to create a process model. A process model can be considered a state model of a system for different process instances. A process model will typically capture multiple process instances as paths or traces through the process model. Typically, a trace includes a beginning state of the system, transitions between states of the system, intermediate states of the system, and an ending state of the system. Each of the transitions corresponds to an event in the system.

### SUMMARY

Current behavior can be evaluated to efficiently identify behavioral anomalies with process models of different scopes and/or different degrees of precision. For meaningful behavioral evaluation of an actor (i.e., a user or a device), these multiple process models are constructed with different sets of event logs of a system. In addition to a process model for the actor at the scope of the individual actor, process models are constructed at the scope of different groups of actors. For instance, the scopes of the process models can be individual actor, role of an actor, and actor community. As an example, a process model can be built based on event logs of an actor; a process model can be built based on event logs of actors having a same role as the actor; and a process model can be built based on event logs of a community of actors (defined or discovered) to which the actor belongs. To identify anomalous behavior of the actor, events generated during an active session of the actor and the system are evaluated against the multiple process models.

This summary is a brief summary for the disclosure, and not a comprehensive summary. The purpose of this brief summary is to provide a compact explanation as a preview to the disclosure. This brief summary does not capture the entire disclosure or all embodiments, and should not be used to limit claim scope.

### BRIEF DESCRIPTION OF THE DRAWINGS

Embodiments of the disclosure may be better understood by referencing the accompanying drawings.

FIG. 1 depicts a conceptual diagram of a system with a behavioral data evaluator evaluating behavioral data from a client's active session to determine any anomalous behavior.

FIG. 2 depicts a flowchart of example operations for evaluating behavioral data of an actor interacting with a system.

FIG. 3 depicts a flowchart of operations for distilling active logs down to primary events.

FIG. 4 depicts a flowchart of example operations for distilling active logs and maintaining parse state of active logs.

FIG. 5 depicts a flowchart of example operations for behavioral data evaluation by model precision.

FIG. 6 depicts a flowchart of example operations for behavioral data evaluation by model scope.

FIG. 7 depicts an example computer system with a multi-model behavioral data evaluator.

### DESCRIPTION

The description that follows includes example systems, methods, techniques, and program flows that correspond to embodiments of the disclosure. However, it is understood that this disclosure may be practiced without these specific details and that the example illustrations should not be used to limit the claims. For instance, the illustrations often refer to a security related use of anomaly detection (e.g., threat detection or intrusion detection). Embodiments are not limited to a security context, though. Embodiments can be used for a variety of purposes including educational contexts, commercial contexts, etc. In those other contexts and/or for other purposes, the anomalous behavior is not necessarily anomalous for the individual under evaluation but may be anomalous at a group scope. Well-known instruction instances, protocols, structures and techniques have not been shown in detail in order not to obfuscate the description.

Terminology

The terminology related to process models is somewhat convoluted. The terms often used in the context of process models include “task,” “task originator” “event,” “process”, and “process instance.” A task refers to a piece of work to be done. The task originator refers to the entity that originates the piece of work to be done (e.g., the entity that requests the work to be done). The task originator requests that a system carry out the task. An event occurs when the system carries out the task. To illustrate, a client device (task originator) requests a read of file X (task) of a server device. To perform the file read, the server opens a connection (first event) with a storage backend and interacts with the backend storage to obtain the file X from the backend storage (second event) and provides the file to the client (third event). Continuing with this illustration, the process could be considered “reading a file” and the process instance is “reading file X.” Although represented in this explanation as a second event, the server interaction with the backend storage is likely comprised of multiple events. The actual “reading” could be considered a sub-process. In some literature, “activity” is used instead of “event” or along with “event” depending on context (e.g., an element in a log is referred to as an event while the representation of that log element in a model is referred to as an activity). The examples herein, however, use the term “event” to avoid obfuscating the descriptions.

Introduction

A log often has multiple sequences of events. A process model created from multiple logs does not capture every sequence of events in all of the logs. In addition, a sequence of events captured in a process model (i.e., process instance) may not be reproduced in its entirety in the process model. The trace that corresponds to a captured sequence of events may be a distilled version of the event sequence that indicates events of interest. The traces indicated in a process model define “normal” behavior for the actor corresponding to the process model in an associated system. The sequence or sequences of events in a log (or across logs) corresponding to an actor are the “behavior” of the actor in the system. Thus, the process model can be used to determine whether behavior of an actor in a system is normal.

Identifying behavioral deviations or anomalies based on events in a system can be complex. The variables that influence this complexity can at least include attributes of an organization associated with the system (e.g., number of roles, number of departments, security policies, etc.), the complexity of the system itself (e.g., number of machines, networks, network devices, etc.), available information about system events, and desired responsiveness for evaluating behavior. In addition, identifying a behavioral anomaly based on system events becomes more challenging when evaluating “current” behavior in a system instead of evaluating “past” behavior of an actor in the system. Evaluating “current” behavior means that the behavior being evaluated is ongoing or the sequence(s) of events is growing while being evaluated. This typically occurs with an active session (i.e., a session that has not yet been terminated) between an actor and the system.

Overview

Current behavior can be evaluated to efficiently identify behavioral anomalies with process models of different scopes. For meaningful behavioral evaluation of an actor (i.e., a user or a device), multiple process models of different scopes are constructed with event logs of a system. In addition to a process model for the actor at the scope of the individual actor, process models are constructed at the scope of different groups of actors that share at least one attribute/characteristic with the actor under evaluation. For instance, the scopes of the process models can be individual actor, role of an actor, and actor community. As an example, a process model can be built based on event logs of an actor; a process model can be built based on event logs of actors having a same role as the actor; and a process model can be built based on event logs of a community of actors (defined or discovered) to which the actor belongs. To identify anomalous behavior of the actor, events generated during an active session of the actor and the system are evaluated against the multiple process models.

### Example Illustrations

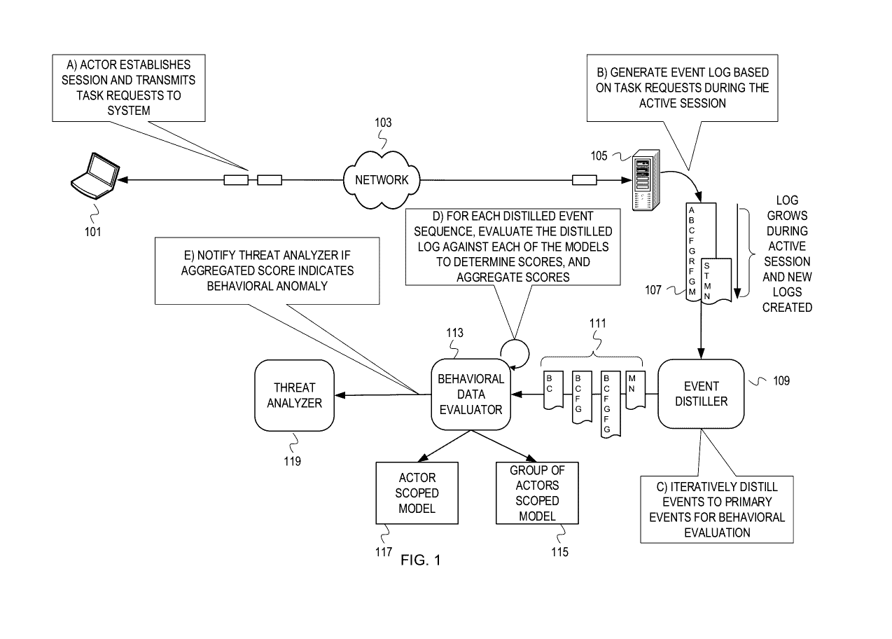

FIG. 1 depicts a conceptual diagram of a system with a behavioral data evaluator evaluating behavioral data from a client's active session to determine any anomalous behavior. In FIG. 1, the system includes a single server 105 to avoid complicating this illustration. An event distiller 109 distills event logs of the system and provides event sequences distilled from the event logs to a behavioral data evaluator 113. The behavioral data evaluator 113 can communicate with a thread analyzer 119. The event distiller 109, the behavioral data evaluator 113, and/or the threat analyzer 119 may be part of the system with the server 105. Any one or all of the event distiller 109, behavioral data evaluator 113, and the threat analyzer 119 may be separate from the system. FIG. 1 depicts a client device 101 coupled communicatively with the server 105 via a network 103.

FIG. 1 is annotated with a series of letters in association with operations. These letters represent stages of for the operations. Although these stages are ordered for this example, the stages illustrate one example to aid in understanding this disclosure and should not be used to limit the claims. Subject matter falling within the scope of the claims can vary with respect to the order and some of the operations.

At stage A, the client device 101 (i.e., actor) establishes a session with the server 105 of the system and transmits task requests to the system via the network 103. The client device 101 can establish a stateful or a stateless session. The server 105 maintains data about the session that at least identifies the session. Examples of session data include a session identifier, a requestor identifier (e.g., network address of the device 101), timing data to maintain the session, etc. A session can be defined by temporal boundaries of interactions between the system and an actor, login credentials, login credentials until a timeout mechanism for lack of communications, etc. The server 105 receives the requests and performs operations in response. The operations performed by the server 105 can include forwarding task requests to other elements of the system (e.g., file server, application server, security device, etc.) and/or determining multiple operations for a requested task and delegating at least some of those operations to other elements of the system.

At stage B, the server 105 generates an event log based on the task requests received during the active session. The server 105 records events triggered by the task requests into event logs 107. In some situations, the server 105 may generate and maintain multiple logs. For instance, login credentials for a user may be used to open multiple active sessions with a system. Or sessions of different protocols can be created concurrently (e.g., a hypertext transfer text protocol (HTTP) session and a file transfer protocol (FTP) session). Elements of the system can maintain multiple logs per active session. In addition, certain events may trigger an element of the system to generate a log for that event and associated events. In FIG. 1, the server 105 generates a first log 107 that records events {A, B, C, F, G, R, F, G, M} over time. Examples of the events may be indications that GET, POST, and OPTION were received in an HTTP session and corresponding operations were performed by a receiving server. FIG. 1 also illustrates the server 105 creating a second log that includes events {S, T, M, N}. A system may create an additional log(s) for various reasons (e.g., a log reaching a maximum size, a period of time expiring, a particular event that triggers creation of its own log, etc.).

At stage C, the event distiller 109 iteratively distills events to primary events for behavioral evaluation. Primary events are events that are predefined as being of interest for behavioral evaluation. Event logs are distilled to avoid overwhelming behavioral evaluation and/or avoid evaluating events that do not have relevancy to behavioral evaluation. Whether an event is a primary event is determined in advance based on observations of live environments and/or test environments. In addition, an event may be conditionally defined as a primary event. For instance, an event may be a primary event depending upon any one of the preceding events, the subsequent events, the type of log, the type of server generating the log, the actor, etc. Therefore, the event distiller 109 can analyze metadata of the log to distill the log. The event distiller 109 iteratively distills the log or logs generated for an actor because the behavioral data is dynamic. The output of this distillation is referred to herein as a distilled live event sequence since the events are based on an active or “live” session. As a log grows with additional events in an active session, the event distiller 109 will add new primary events to the distilled live event sequences for evaluation by the behavioral data evaluator 113. The event distiller 109 also extracts primary events based on new logs of the actor. Since distillation is iterative, the event distiller 109 provides multiple distilled live event sequences 111 to the behavioral data evaluator 113 over time.

At stage D, the behavioral data evaluator 113 evaluates each distilled event sequence. The behavioral data evaluator 113 evaluates each distilled event sequence against each of multiple models. Each of the models has a different scope in relation to the actor. The actor, in FIG. 1, may be the device 101 or the user of the device as represented by a user identifier or login credential supplied to the server 105. The behavioral data evaluator 113 determines normality scores based on the evaluations against the models and then aggregates the normality scores into an aggregated normality score. The behavioral data evaluator 113 uses the aggregate normality score to determine whether to notify the threat analyzer 119 of possible anomalous behavior by the actor.

In FIG. 1, the models include an actor scoped model 117 and a group of actors scoped model 115. The actor scoped model 117 will have been constructed based on historical logs of the actor or artificial logs created for the actor (e.g., events expected to occur in the system based on expected tasks to be requested by the actor). The group of actors scoped model 115 will have been constructed with historical logs of other actors, and perhaps the actor, that share an attribute with the actor. This attribute can be defined or discovered. A defined attribute may be a role. For example, the group of actors scoped model 115 may have been constructed based on historical logs of all actors (or a selected subset of actors) in an organization that have a same defined role (e.g., administrator) as the actor being evaluated. The group of actors scoped model 115 will likely be less precise than the actor scoped model 113 since it was constructed based on logs of other actors. Being less precise can mean that the model captures process instances that are performed less frequently by the actor than by other actors having the defined attribute in common. Being less precise can also mean that the model captures process instances that have not been performed (to date) by the actor and/or does not capture process instances that the actor performs. If process instances are not captured in the group of actors scoped model 115, then those process instances are likely performed by the actor outside of the typical activities of that role. Additional group of actors scoped models of more or less precision can also be used. For instance, a model can be constructed based on multiple common attributes. A model can be constructed that includes process instances of the actor model with various weighting. A model can be constructed with a same scope but different precision (e.g., different numbers of actors sharing an attribute are used for construction of different models).

As mentioned above, a model can be constructed from a discovered community of actors. The group of actors that is the basis for this model is considered a discovered community because a similarity is discovered. The similarity can be discovered with various techniques. For example, an input set of actors can be analyzed to discover similarities among them. The input set of actors may be all actors with event data or process data available for analysis by a system, or actors that satisfy one or more defined criteria. Examples of criteria include organizational or departmental membership of actors, a specified role, usernames within a particular domain, etc. As an example, actors can be selected based on attribute parameters (e.g., actors with number of defined roles greater than 3, actors who access similar resources, actors in a particular subnet, etc.).

After the input set of actors is determined, models can be constructed for each of the actors in the pool and distances between the models determined. The “distance” between models is a value representing the degree of similarity between models based on statistical analysis. As a few illustrative examples, distance can be based on the number of similar process instances occurring in two models, the degree of similarity of the process instances, and/or the frequency of similar process instances. To be similar process instances, at least some of the activities in the similar process instances occur in a same sequence. To illustrate, a process instance 1 in a process model A includes activities {A, B, E, R, S, T}. A process instance 2 in a process model B includes activities {B, D, E, M, R, S, V}. These process instances can be considered similar since they both include activities {B, E, R, S}. The degree of similarity between these process instances can take into account the different starting activities, different ending activities, intervening activities (e.g., M occurs between E and R in process instance 2), and frequency of {B, E, R, S}. The frequency of a process instance in a process model is an indication of a number of times that process instance occurred in the event logs that were mined to construct the process model. Determination of similarity between process instances will vary depending on the employed statistical analysis and configured parameters. The statistical analysis for determining distances can vary. A cophenetic distance can be determined for different pairs of models based on comparing the last element connected to every two activities in each of the models. Using a shortest path algorithm, distance between every two activities in each pairing of models can be determined. After determining distances among the models, clustering can be employed to discover similar models. Examples of algorithms that can be used to cluster the models include a k-means clustering algorithm, a K q-flats algorithm, a k-medoids clustering algorithm, a hierarchical clustering algorithm, a fuzzy clustering algorithm, a nearest neighbor chain algorithm, a neighbor joining algorithm, etc. The result of the clustering can be used to create a model for a particular actor (e.g., create a model based on a cluster that includes the particular actor), can be used to create multiple models for a particular actor (e.g., create models based on the cluster that includes that particular actor and n models based on the m nearest clusters, where n<=m), and/or can be used to create multiple models based on yielded clusters (e.g., create n models from m clusters, wherein where n<=m)

Returning to FIG. 1, the behavioral data evaluator 113 notifies the threat analyzer 119 at stage E if an aggregate normality score for an actor indicates a behavioral anomaly. If a notification is provided, the threat analyzer 119 can provide feedback to the behavioral data evaluator 113 (e.g., verifying whether the anomaly was a threat). This feedback can be used to revise the models used by the behavioral data evaluator 113. The behavioral data evaluator 113 can revise the models or another module, perhaps the module that constructed the models, can revise the models. Revision of the models can help reduce false indications of anomalous behavior. In addition to revising the models, feedback from the threat analyzer 119 can be used to create threat models. For instance, the threat analyzer 119 can indicate to the behavior data evaluator 113 (or a model constructor) the process instance confirmed as a threat. The confirmed threat process instances can be used to construct a threat model used to evaluate current behavior. If a process instance matches a threat model, then the behavioral data evaluator 113 can provide a notification to the threat analyzer 119.

Although given particular names in FIG. 1, the program code that carries out the operations associated with the modules depicted in FIG. 1 are used to simplify the illustration. Names can vary by platform, program language, developer, etc. In addition, the “behavioral data evaluator,” “the event distiller,” and the “threat analyzer” can be instantiated as a single program, different programs, a single program distributed across different devices, etc. For consistency with FIG. 1, the following flowcharts are described with reference to the event distiller or the behavioral data evaluator. For word economy, the event distiller is referred to in the flowcharts as the distiller and the behavioral data evaluator is referred to as the evaluator. Regardless of the name, the example operations can be carried out by a program or programs with a different name and realized with various functions, procedures, methods, etc., depending upon the platform and/or program language. In addition, any suggested architecture or particular implementations described or suggested by FIG. 1 should not be construed as required throughout due to the reference back to monikers used in FIG. 1.

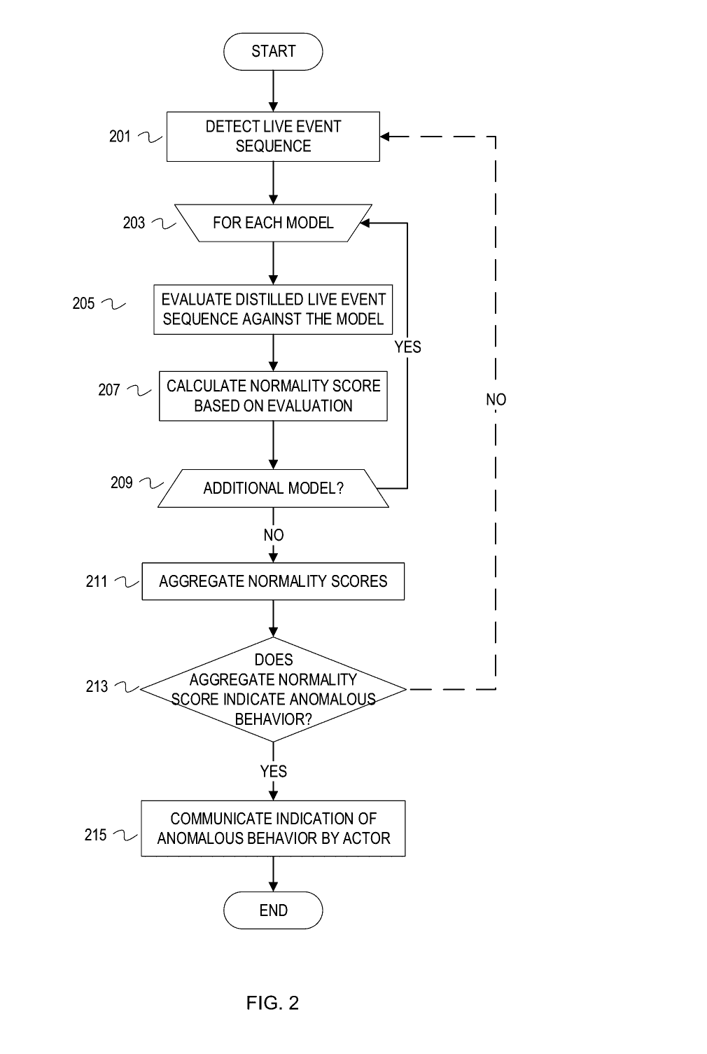

FIG. 2 depicts a flowchart of example operations for evaluating behavioral data of an actor interacting with a system. FIG. 2 refers to these operations as being performed by an evaluator.

An evaluator detects a distilled live event sequence (201). The distilled live event sequence indicates events of an actor with one or more active sessions with a system associated with the evaluator. The evaluator can detect a distilled live event sequence differently. The evaluator may receive a message that indicates the distilled live event sequence. The evaluator may receive the distilled live event sequence itself or a reference to the distilled live event sequence. In addition, the evaluator may periodically access a memory location(s) in which distilled live event sequences are posted.

After detecting a distilled live event sequence, the evaluator begins behavioral evaluation of the distilled live event sequence against models corresponding to the actor under evaluation (i.e., the actor corresponding to the distilled live event sequence) (203).

The evaluator then evaluates the distilled live event sequence against one of the models (205). For example, the evaluator determines whether the process instance expressed in the distilled live event sequence is similar to a trace in the model (e.g., a subgraph of the model) based on an edit distance or Levenshtein distance ascertained from graph traversal operations. The evaluator can be configured with a threshold for determining whether a process instance expressed in a distilled live event sequence is similar to a trace in the model, and that threshold can be defined differently for each model. For instance, a process instance with at least 60% matching events/activities in order of a trace may be considered similar. This determination of similarity can take into account various factors, such as number of elements (i.e., events/activities) of the process instance that have intervening elements in the counterpart trace. Similarity can be determined based on other techniques that compare the distilled live event sequence against multiple traces of the process model, such as a longest common subsequence technique or a longest common prefix technique. Other techniques for determining similarity between the model and the distilled live event sequence can also be used depending on how the model and the distilled live event sequence are expressed. For example, a model and a live event sequence can be expressed as finite-state automatons or state machines. To determine similarities between the model and live event sequence expressed as state machines, progress in state can be compared between state machine expressions of traces and a state machine expression of the distilled live event sequence.

Based on the evaluation, the evaluator calculates a value that represents normality of the process instance expressed in the distilled live event sequence with respect to the model (207). This value is referred to herein as a “normality score.” The evaluator can determine a degree to which the process instance in the distilled live event sequence is similar to a trace in the model, and then calculate a normality score based on the degree of similarity. Referring back to the example of a 60% floor for similarity, the evaluator can base the normality score on the remaining scale between 0.6 and 1.0. The evaluator can also factor in occurrence frequency of the trace in the model for calculating the normality score, if that value is provided for the model.

If there is an additional model against which the distilled live event sequence has not yet been evaluated, then the evaluator repeats the evaluation and scoring for that model (209).

Otherwise, the evaluator aggregates the calculated normality scores (211). As stated earlier, there are multiple models for the actor under evaluation. The models can vary in scope and/or precision. Typically, the scope of the model corresponds to precision of the model with respect to the actor. But that may not always be the case. In the preceding example, a more precise model and a less process model may have a same scope (e.g., same defined role) but the precision can vary based on the number of actor models used as a basis for constructing the model. Aggregation of normality scores can take into account the precision and/or scope of the models. For instance, the evaluator may assign weights to the normality scores in accordance with the corresponding model's precision and then average the weighted normality scores. The aggregation can also vary by context. As an example, an evaluator can give greater weight to higher precision models or models with smaller scope when evaluating behavior of an actor with a higher level of security clearance. The evaluator can also be configured to allow smaller variances from the models for actors with a higher level of security clearance. In contrast, the evaluator may not weigh normality scores of different models when evaluating behavioral data of an actor with a low level of security. This variation in parameters to identify anomalous behavior may also vary depending upon the purpose of the evaluation. For example, an evaluator deployed in an educational context may be configured to capture more behavior as anomalous when anomalous behavior corresponds to exceptional learning (e.g., accessing and completing books of advanced topics) or corresponds to a need for assistance (e.g., repeatedly accessing the same level of assignments).

The evaluator determines whether the aggregate normality score indicates an anomalous behavior of the actor under evaluation (213). For example, the evaluator determines whether the aggregate normality score falls below a normality threshold defined for the actor or organization of the actor. As with the other evaluation parameters, the threshold normality score for identifying behavior as anomalous can be defined different by any of actor, actor attribute, organization, number of active sessions, etc. The evaluator can also be configured to adjust a normality score threshold based on particular criteria. For example, the evaluator may adjust a normality threshold to be more stringent when n sessions are active for an actor or if a security failure has occurred within a defined time period. If the evaluator determines that the aggregate normality score does not indicate anomalous behavior, then the evaluator returns to a state of detecting any new or pending distilled live event sequences. The line from block 213 to block 201 is dashed to indicate the possible asynchronous change in state of the evaluator (e.g., the evaluator may wait for a next distilled live event sequence).

If the evaluator determines that the aggregate normality score indicates anomalous behavior in the actor's session, then the evaluator communicates the indication of the anomalous behavior by the actor (215). The evaluator can communicate the detection of anomalous behavior differently depending upon deployment environment, system elements, etc. For instance, the evaluator may generate a notification to a system administrator with an identifier of the actor. The evaluator may generate a notification to a threat analyzer with indications of the session endpoints and the actor.

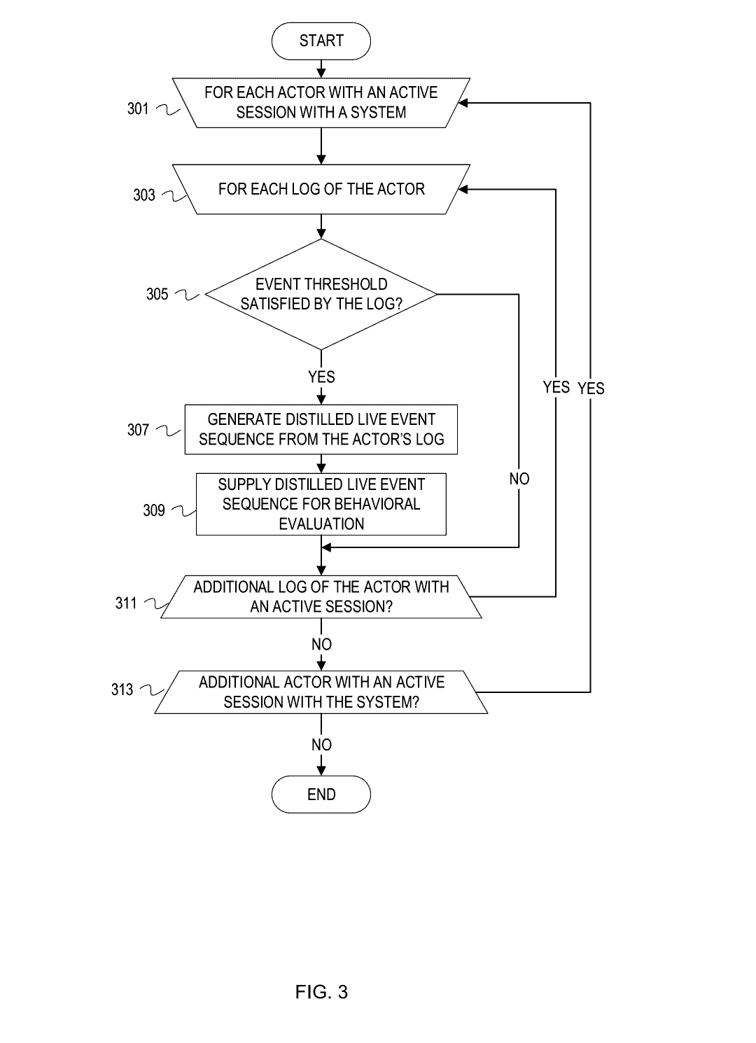

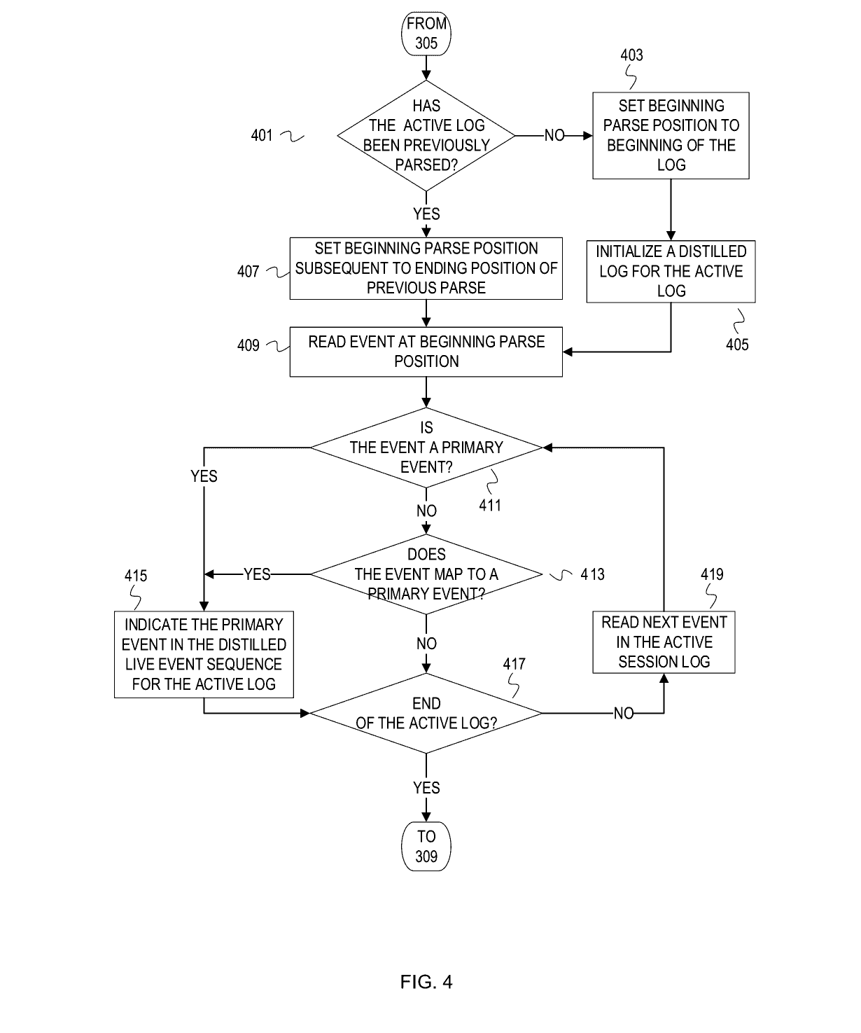

Although a behavioral data evaluator can evaluate logs in their entirety, this is likely too much information for timely and efficient evaluation, especially for evaluating current behavioral data. Therefore, a program (“distiller”) distills the detailed logs down to information (“distilled live event sequences”) with events previously identified as information (or more informative) for evaluation. FIGS. 3-4 illustrate flowcharts of example operations for distilling logs for current behavioral data evaluation. As mentioned earlier, FIGS. 3 and 4 refer to a distiller performing the example operations for ease of understanding in light of FIG. 1.

FIG. 3 depicts a flowchart of operations for distilling active logs down to primary events.

Since a distiller may be responsible for distilling logs across multiple sessions of multiple actors in a system, the distiller iterates over each actor with an active session with the system (301). The distiller can respond to notifications of active sessions. As another example, the distiller can access data maintained by the system that indicates active sessions with the system and the corresponding actors.

As the distiller iterates over each actor with an active session, the distiller also iterates over the logs of the actor (“active logs”) if there are multiple active logs (303). The system may maintain an active log for each session of the actor. In addition, certain tasks requested by the actor may cause the system to generate a different log for the task.

For each active log, the distiller determines whether an event threshold is satisfied by the active log (305). Although an active log may have been generated, there may not be enough entries in the active log for useful behavioral evaluation. The event threshold can be predefined and multiple thresholds can be defined for different situations (e.g., different types of logs). The event threshold can be defined based on different metrics (e.g., number of entries, log size as measured in occupied memory space, etc.). Multiple event thresholds can also be defined. For instance, the distiller may wait to distill an active log until there are at least 20 entries or until a defined time period has passed since creation/update of the active log.

If the distiller determines that the event threshold is satisfied, then the distiller generates a distilled live event sequence from the actor's active log (307). The distiller determines primary events in the active log and writes those to a distilled live event sequence. The distiller can create a new distilled live event sequence for each iteration. The distiller can also maintain a distilled live event sequence for each active log and update the distilled live event sequence. For instance, the distiller can create a distilled live event sequence A′ from an active log A. When the distiller encounters log A again with additional events, the distiller can distill the new portion of log A and add any primary events from that new portion to the distilled live event sequence A′.

After generating the distilled live event sequence, the distiller supplies the distilled live event sequence for behavioral evaluation (309). The distiller can transmit the distilled live event sequence, transmit a notification of location of the distilled live event sequence, write the distilled live event sequence to a location specified for distilled live event sequences, etc.

After supplying the distilled live event sequence for behavioral evaluation or after determining that the event threshold was not satisfied, the distiller proceeds to the next active log of the actor (311).

If there are no additional active logs for the actor currently under evaluation, then the distiller proceeds to the next actor with an active session with the system (313).

FIG. 4 depicts a flowchart of example operations for distilling active logs and maintaining parse state of active logs. FIG. 4 can be an example set of operations for block 307 of FIG. 3.

The distiller determines whether the active log has been previously parsed (401). As the distiller parses an active log, the distiller can maintain an indication of parse state or parsing progress for that active log. This can be in the form of a line number, a memory location, a log offset, a timestamp, etc., indexed by an identifier of the active log. To determine whether an active log has been previously parsed, the distiller can determine whether there is any parsing state data for the active log.

If the distiller determines that the active log has not been previously parsed, then the distiller sets a beginning parse position (e.g., a pointer) to a beginning of the active log (403). The “beginning” of the log may be after a header or metadata of the log. The beginning of the log refers to a first event entry in the active log.

After setting the beginning parse position, the distiller initializes a distilled live event sequence for the active log (405). For example, the distiller instantiates a distilled live event sequence data structure with an identifier of the active log. The active log identifier can be, for example, a combination of a session identifier and an actor identifier.

If the active log had been previously parsed, then the distiller sets the beginning parse position subsequent to an ending position of a previous parse (407). If parse position is indicated with line number, this can be incrementing the line number of the previous parse. If parse position is based on timestamp, then the distiller can locate the timestamp of the last parsed event and set the beginning parse position at the next timestamp.

If the active log had been previously parsed or after initializing the distilled live event sequence for the active log, the distiller reads the entry (i.e., event) at the beginning parse position (409). The distiller may apply a mask to each entry to determine the event of the entry. The distiller can locate the event after a particular delimiter, an offset within an entry, after a particular field, etc.

The distiller determines whether the event read from the entry is a primary event (411). The distiller may compare the event against a list of defined primary events.

If the event is a primary event, then the distiller indicates the event in the distilled live event sequence for the active log (415).

If the event is not a primary event, then the distiller determines whether the event maps to a primary event (413). Some events may occur on condition of occurrence of a primary event. Other events may be variations of a primary event, the details of which may not provide further insight for behavioral evaluation than the corresponding primary event. For these cases, the events can be mapped to a primary event since the primary event was defined as being of interest for behavioral evaluation. Mapping is the association of the event to the primary event (e.g., a table of associations, event codes that reference primary event codes or include primary event codes, etc.). If the event maps to a primary event, then the distiller indicates the primary event in the distilled live event sequence of the active log (415).

If the event does not map to a primary event or after indicating a primary event in the distilled live event sequence, the distiller determines whether the end of the active log has been reached (417). If the end of the active log has been reached, then the distiller proceeds to the next log or next actor.

If the distiller has not reached the end of the active log, then the distiller reads the next event in the active log (419). After reading the next event in the active log, the distiller again makes a determination of whether the read event is a primary event or maps to a primary event.

Although FIGS. 3 and 4 refer to active logs (i.e., logs corresponding to active sessions), an active log can include a log of a session that has been recently terminated. The distiller can be configured to continue distilling logs that were active within a last t minutes, for example. This allows for evaluation to continue without losing possibly useful behavioral data of an actor's session that has recently terminated or been interrupted.

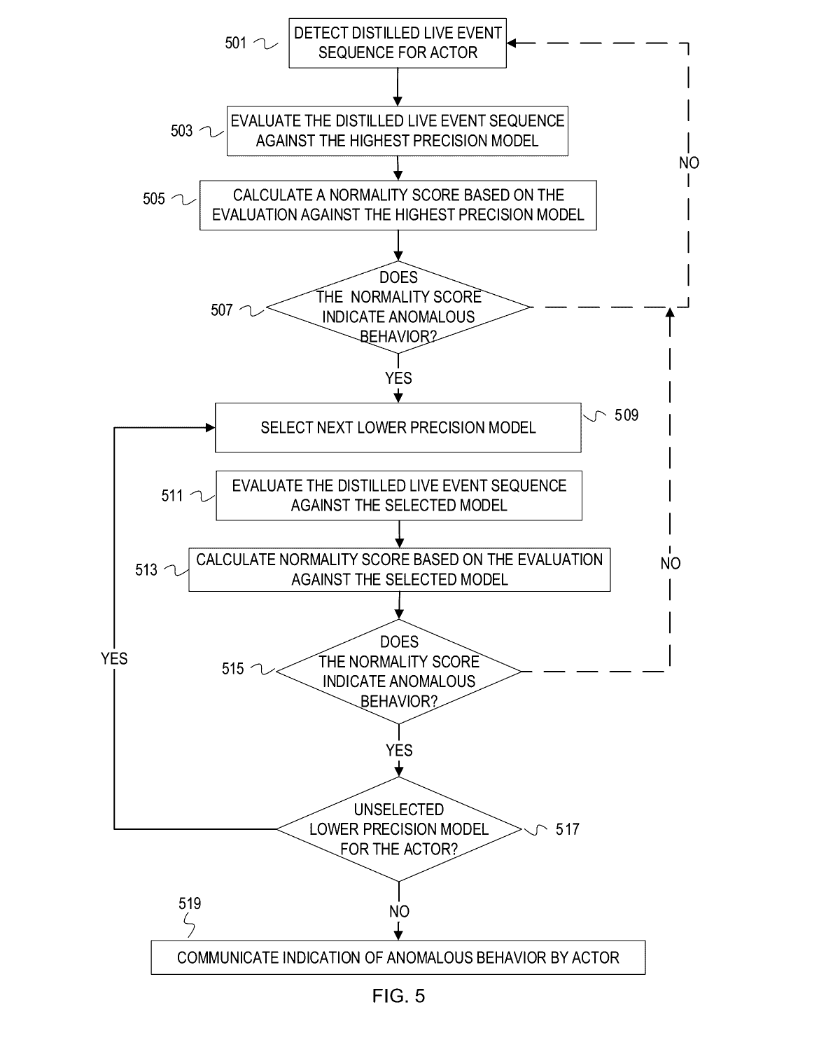

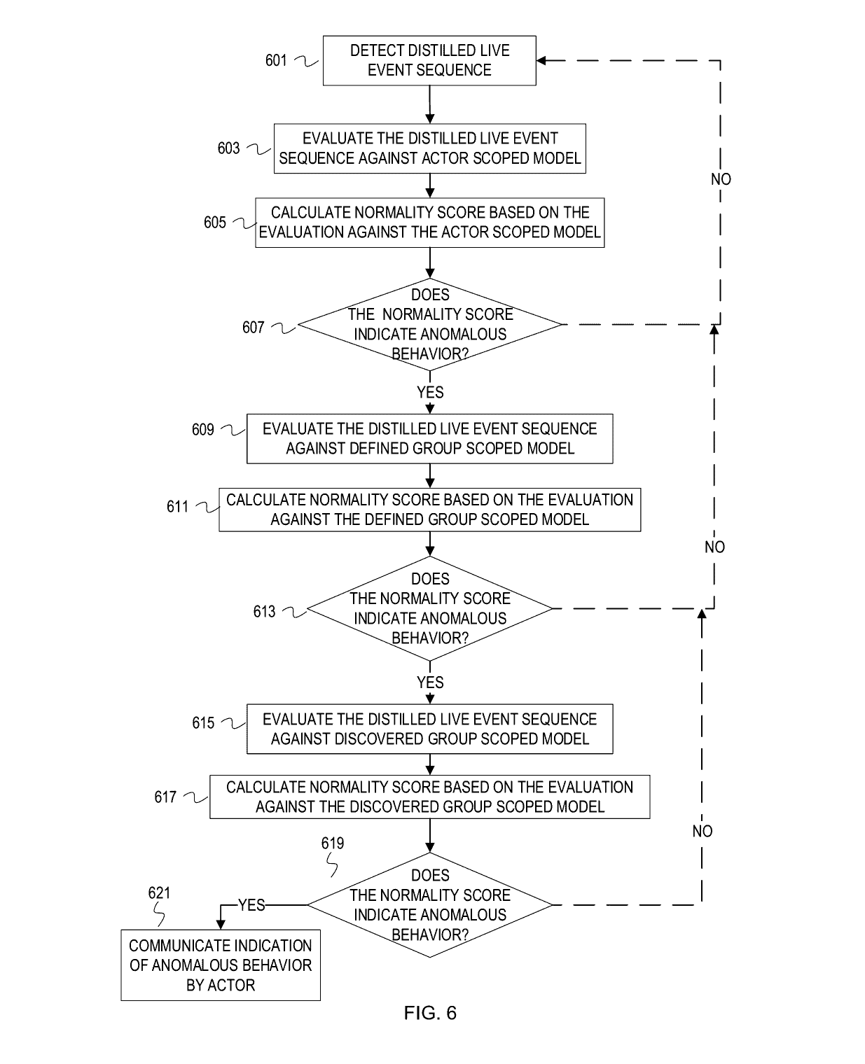

Although the preceding examples aggregate normality scores across the multiple models of different scope and/or precision, score aggregation is not necessary. The models can be used to validate evaluation results by precision of the model. Using less precise models of likely greater scope can help to take into account a seeming anomaly that is actually normal across a community, for example. A determination of a behavioral anomaly with a higher precision model is validated with a lower precision model. FIGS. 5 and 6 depict flowcharts of example operations for anomaly validation by model precision/scope.

FIG. 5 depicts a flowchart of example operations for behavioral data evaluation by model precision.

An evaluator detects a distilled live event sequence for an actor (501).

The evaluator evaluates the distilled live event sequence against the highest precision model (503). The degree of precision is relative to the models available/relevant for evaluating the actor's behavioral data. The highest precision model may be the model that is actor scoped (i.e., constructed based on logs of the actor). However, models with a same scope can have different degrees of precision. Two models may be actor scoped, but a first actor scoped model may capture more traces and frequency of those traces than a second actor scoped model. In addition, a higher precision model actor scoped model may be constructed with more logs over a greater time period than a lower precision actor scoped model.

After evaluation, the evaluator calculates a normality score based on the evaluation against the highest precision model (505). For example, the evaluator may calculate a normality score of 0 if the process instance expressed by the distilled live event sequence does not match any trace in the highest precision model within a configured degree of acceptable variance.

The evaluator then determines whether the normality score indicates an anomalous behavior for the actor (507). If the normality score calculated from evaluation against the highest precision model does not indicate an anomaly, then the evaluator proceeds to a next log for the actor (or another actor). This presumes that the lower precision models will not indicate an anomaly if a higher precision model does not indicate an anomaly.

If the normality score from the highest precision model indicates a behavioral anomaly, then the evaluator selects a next lower precision model (509). The models or references to the models can be ordered in order of precision or metadata can be used to indicate degree of precision among the models.

The evaluator evaluates the distilled live event sequence against the selected lower precision model (511).

After evaluation, the evaluator calculates a normality score based on the evaluation against the selected lower precision model (513).

The evaluator then determines whether the normality score indicates an anomalous behavior for the actor (515). If the normality score calculated from evaluation against the selected lower precision model does not indicate an anomaly, then the evaluator proceeds to a next log for the actor (or another actor).

If the normality score from the selected lower precision model indicates a behavioral anomaly, then the evaluator selects a next lower precision model if there is an additional, unselected model of lower precision than the currently selected model (517).

If the selected lower precision model normality score indicates an anomaly and there is no additional, unselected lower precision model, then the evaluator communicates an indication of anomalous behavior by the actor (519). The indication is communicated for further analysis for validation and/or action.

FIG. 6 depicts a flowchart of example operations for behavioral data evaluation by model scope. FIG. 6 is similar to FIG. 5, but guided by model scope instead of model precision.

An evaluator detects a distilled live event sequence for an actor (601).

The evaluator evaluates the distilled live event sequence against an actor scoped model (603). As previously discussed, the actor scoped model is constructed based on logs of the actor.

After evaluation, the evaluator calculates a normality score based on the evaluation against the actor scoped model (605).

The evaluator then determines whether the normality score indicates an anomalous behavior for the actor (607). If the normality score calculated from evaluation against the actor scoped model does not indicate an anomaly, then the evaluator proceeds to a next log for the actor (or another actor).

If the normality score from the actor scoped model indicates a behavioral anomaly, then the evaluator evaluates the distilled live event sequence against a defined group scoped model (609). The defined group scope model is a model constructed from logs of actors that have at least one defined attribute in common with the actor, and can include logs of the actor.

After evaluation, the evaluator calculates a normality score based on the evaluation against the defined group scoped model (611).

The evaluator then determines whether the normality score indicates an anomalous behavior for the actor (613). If the normality score calculated from evaluation against the defined group scoped model does not indicate an anomaly, then the evaluator proceeds to a next log for the actor (or another actor).

If the normality score from the defined group scoped model indicates a behavioral anomaly, then the evaluator evaluates the distilled live event sequence against a discovered group scoped model (615). The discovered group scoped model is constructed from logs of actors discovered to be similar to the actor, example techniques for which are described above.

After evaluation, the evaluator calculates a normality score based on the evaluation against the discovered group scoped model (617).

The evaluator then determines whether the normality score indicates an anomalous behavior for the actor (619). If the normality score calculated from evaluation against the discovered group scoped model does not indicate an anomaly, then the evaluator proceeds to a next log for the actor (or another actor).

If the discovered group scoped model normality score indicates an anomaly, then the evaluator communicates an indication of anomalous behavior by the actor (621). The indication is communicated for further analysis for validation and/or action.

Variations

The example illustrations refer to a single system or service in which events are occurring for an actor. However, events of an actor across multiple systems and/or services can be evaluated. An actor may have multiple accounts and/or identities across multiple systems and/or services. The actor may access the multiple systems and/or services concurrently or separately. To detect possible anomalous behavior for an actor with events across multiple systems and/or services, a process model can be constructed for each account and/or identity. A process model can also be constructed from input sets of actors based on the different systems and/or services. The normality scores can also be evaluated in correspondence with the different system/service models. Thus, possible anomalous behavior can be reported per system or service. However, a process model need not align with the different identities or accounts. A process model can be constructed for the actor based on events across accounts and/or identities that span the multiple systems and/or services. In this case, normality scores can indicate a possible anomalous behavior for an actor when taking all or multiple of the different accounts and/or identities into account.

The models used for behavioral data evaluation are likely revised periodically to adapt to changes in behavior of organizations, departments, roles, actors, etc. The group scoped models can also be revised to adapt to current changes in behavior, which then adapts the behavioral evaluation to take into account the current changes. A sudden change in behavior of a group can occur for many reasons. An infrequent event may cause an occurrence of atypical behavior across a department (e.g., a tax audit of a corporation). A change in process or organizational culture may occur due to a change in leadership, change in a law, reaction to a failed security process, etc. To account for this and adapt the behavioral data evaluation to these possible group sized changes, the group scoped models can be revised at a higher frequency, for at least a defined time period, and can be revised with current behavioral data across a group of actors. For example, a model constructor can revise or construct a new a model scoped to a department within an organization. The model constructor can construct or revise the department scoped model on a daily basis and replace the group scoped model used in behavioral data evaluation. The model constructor can also revise a group scoped model with current actor behavioral data of actors within a group scope and update or replace the group scoped model in use for behavioral evaluation periodically.

Some of the example illustrations (e.g., FIG. 1) refer to a server. The server is used to provide an example illustration without inundating the reader with multiple variations in the beginning Operations performed by servers in these example illustrations may be performed by program code running on a device that is not typically considered a server (e.g., a mobile device). The operations could be performed by a servlet or service, as examples. A service could be a running program or program(s). Furthermore, the running program or programs may be distributed across multiple devices.

The example illustration of FIG. 2 refers to aggregating weighted normality scores and using that sum to detect possibly anomalous behavior, but embodiments are not so limited. A system can select the minimum normality score or the maximum normality score, and compared the selected normality score against a normality threshold to detect possibly anomalous behavior. A system can compute a median normality score or a weighted geometric mean of the normality scores, and compare the computed normality score against a normality threshold to detect possibly anomalous behavior. As yet another example, a system can use multiple thresholds to detect possibly anomalous behavior. A normality threshold can be defined for each process model. If n models have a normality score that exceeds their corresponding normality threshold, then, an indication of possible anomalous behavior is generated.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 203, 205, 207, and 209 of FIG. 2 indicate sequential evaluation of a distilled live event sequence against models of an actor. However, the distilled live event sequence can be evaluated against the models concurrently. In FIG. 3, the distiller evaluates logs by actor. But a distiller can distill logs in a round robin fashion, for example proceeding to a next actor after distilling n logs for a current actor. With respect to FIG. 5, the distilled live event sequence can be evaluated against the model of different prevision concurrently. And then the scores from those evaluations can be used in sequence from highest prevision to lowest precision to determine an anomaly. Furthermore, normality score of a higher precision model can guide the evaluator to skip models of intermediate precision. For instance, a normality score of 0 can cause the evaluator to skip to the lowest precision model. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

The examples refer to various modules including a behavioral data evaluator, an event distiller, a model constructor, and a threat analyzer. These modules are constructs used to refer to implementation of functionality described in association with these modules. These constructs are utilized since numerous implementations are possible. For instance, a behavioral data evaluator may be a particular component or components of a device (e.g., a particular circuit card enclosed in a housing with other circuit cards/boards), machine-executable program or programs, firmware, a circuit card with circuitry configured and programmed with firmware for evaluating behavioral data against process models, etc. The terms are used to efficiently explain content of the disclosure. Although the examples refer to operations being performed by an evaluator or a distiller, different entities can perform different operations. For instance, a dedicated co-processor or application specific integrated circuit can be configured/programmed to both distill event logs and evaluate distilled live event sequences against process models.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium. A machine-readable storage medium is not a transitory, propagating signal.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

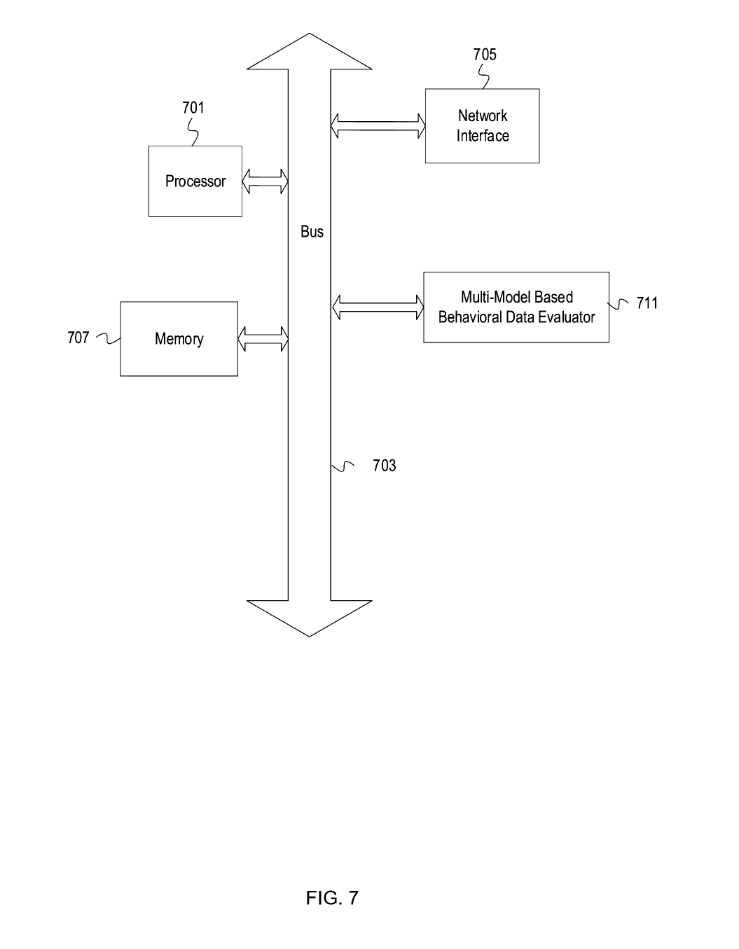

FIG. 7 depicts an example computer system with a multi-model behavioral data evaluator. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes a multi-model behavioral data evaluator 711. The multi-model behavioral data evaluator 711 evaluates current behavioral data of an actor in the context of a system against process models of different scope and/or precision to determine a behavioral anomaly with respect to that actor. Any one of the previously described functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the disclosure is described with reference to various implementations and exploitations, it will be understood that these implementations and exploitations are illustrative and that the scope of the claims is not limited to them. In general, techniques for evaluating system events of an actor against multiple process models of different scope and/or precision as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
evaluating behavioral data of an actor against a first process model and a second process model at least while a session of the actor is active with a system, wherein the first process model has a scope of the actor and the second process model has a scope of a first group of actors, wherein the behavioral data is based, at least in part on, events logged by the system during the session;
determining a first value for the actor based, at least in part, on the evaluating, wherein the first value measures normality of the behavioral data with respect to the first process model and the second process model;
comparing the first value against a second value; and
indicating at least one of the actor and the behavioral data of the actor as anomalous depending upon the comparing.

2. The method of claim 1 further comprising:
determining a third value for the actor based, at least in part, on the evaluating of the behavioral data against the first process model; and
determining a fourth value for the actor based, at least in part, on the evaluating of the behavioral data against the second process model;
wherein determining the first value comprises computing the first value based, at least in part, on the third value and the fourth value.

3. The method of claim 2 further comprising:
evaluating the behavioral data of the actor against a third process model, as well as the first and the second process models, at least while the session of the actor is active with the system,
wherein the third process model has a scope of a second group of actors,
wherein the first group of actors have similar behavioral data according to statistical analysis and the first group of actors includes the actor;
wherein each of the second group of actors have an attribute, which is defined, in common with the actor; and
determining a fifth value for the actor based, at least in part, on evaluating of the behavioral data against the third process model;
wherein determining the first value comprises computing the first value also based, at least in part, on the fifth value.

4. The method of claim 3 further comprising discovering that the first group of actors has similar behavioral data.

5. The method of claim 4 further comprising creating the third process model with behavioral data of the first group of actors.

6. The method of claim 5 further comprising updating the third process model based, at least in part, on at least one of events of the first group of actors logged by the system during sessions that were active within a defined time period and events of the first group of actors logged by the system during active sessions.

7. The method of claim 1 further comprising:
evaluating the behavioral data of the actor against a third process model and a fourth process model, in addition to the first and second process models, at least while the session of the actor is active with the system,
wherein the third process model has a scope of a second group of actors,
wherein the fourth process model has a scope of a third group of actors,
wherein the first group of actors have similar behavioral data according to statistical analysis and the first group of actors includes the actor;
wherein each of the second group of actors have a role attribute in common with the actor,
wherein the third group of actors have a defined community attribute in common with the actor; and
wherein determining the first value for the actor is based, at least in part, on evaluating against the third and fourth process models as well as the first and second process models.

8. The method of claim 7, wherein determining the first value comprises:
determining a third value for the actor based, at least in part, on the evaluating of the behavioral data against the first process model;
determining a fourth value for the actor based, at least in part, on the evaluating of the behavioral data against the second process model;
determining a fifth value for the actor based, at least in part, on the evaluating of the behavioral data against the third process model;
determining a sixth value for the actor based, at least in part, on the evaluating of the behavioral data against the fourth process model;
wherein determining the first value comprises computing the first value based, at least in part, on the third, the fourth, the fifth, and the sixth values.

9. The method of claim 1, wherein indicating, at least one of, the actor and the behavioral data as anomalous comprises supplying an indication of, at least one of, the actor and the behavioral data for determination of a threat to the system.

10. The method of claim 1 further comprising creating the first process model based, at least in part, on historical event data of the actor and the second process model based, at least in part, on event data of the first group of actors.

11. The method of claim 1 further comprising iteratively distilling the logged events to multiple subsets of the logged events as the logged events increase during the active session, wherein the multiple subsets of the logged events are those of the logged events previously indicated as relevant to behavioral evaluation, wherein the behavioral data comprises the multiple subsets of the logged events.

12. The method of claim 11, wherein evaluating the behavioral data comprises evaluating each of the multiple subsets of the logged events against the first and the second process models.

13. A set of one or more non-transitory machine-readable media having program code for live behavior evaluation stored therein, the program code comprising instructions to:
calculate a plurality of normality scores for an actor at least while a session of the actor is active with a system,
wherein a first normality score of the plurality of normality scores is calculated based, at least in part, on event data of the actor logged during the session and a first model that models normal event based behavior of the actor;
wherein a second normality score of the plurality of normality scores is calculated based, at least in part, on event data of the actor logged during the session and a second model that models normal event based behavior of a first group of actors that are statistically similar to the actor;
aggregate the plurality of normality scores into an aggregate normality score; and
indicate behavior of the actor to be anomalous depending upon the aggregate normality score.

14. The set of non-transitory machine-readable media of claim 13, wherein a third normality score of the plurality of normality scores is calculated based, at least in part, on event data of the actor logged during the session and a third model that models normal event based behavior of a second group of actors that have an attribute in common with the actor.

15. The set of non-transitory machine-readable media of claim 13, further comprising program code to update the second model prior to calculation of the second normality score and while the session of the actor is active, wherein update of the second model is based, at least in part, on event data logged during active sessions with the system of at least a subset of the first group of actors.

16. An apparatus comprising:
a processor; and
a machine-readable medium comprising program code executable by the processor to cause the apparatus to,
evaluate behavioral data of an actor against each of a plurality of process models in order of decreasing precision of the plurality of process models at least while a session of the actor is active with a system and until either a determination that the behavioral data is not anomalous or that the behavioral data has been evaluated against all of the plurality of process models, wherein the behavioral data is based, at least in part on, events logged by the system during the session,
after each evaluation of the behavioral data,
determine a value for the actor based, at least in part, on the evaluation, wherein the value measures normality of the behavioral data with respect to the process model of the plurality of process models against which the behavioral data was evaluated;
determine whether the behavioral data is anomalous based, at least in part, on the value;
in response to a determination that the behavioral data is not anomalous, restart the evaluation to include an additional event or events logged by the system;
in response to a determination that the behavioral data is anomalous and the process model against which the behavioral data was evaluated is the last of the plurality of the process models in the order of decreasing precision, indicate that at least one of the actor and the behavioral data is anomalous;
in response to a determination that the behavioral data is anomalous and the process model against which the behavioral data was evaluated is not the last of the plurality of the process models in the order of decreasing precision, evaluate the behavioral data against a next of the plurality of process models according to the order.

17. The apparatus of claim 16, wherein at least two of the plurality of process models with different precisions have a same scope with respect to the actor, wherein the scope is either actor scoped or group scoped.

18. The apparatus of claim 16, wherein the program code to determine whether the behavioral data is anomalous based, at least in part, on the value comprises the program code to:
compare the value against a threshold.

19. The apparatus of claim 16, wherein the machine-readable medium further comprises program code to iteratively distill logged events to multiple subsets of the logged events as the logged events increase during the active session, wherein the multiple subsets of the logged events are those of the logged events previously indicated as relevant to behavioral evaluation, wherein the behavioral data comprises the multiple subsets of the logged events.

20. The apparatus of claim 19, wherein the machine-readable medium comprises program code to retrieve a new one of the multiple subsets of the logged events after evaluation of a current one of the multiple subsets against the plurality of process models without an indication of anomalous behavior.
